(19) United States
(12) Patent Application Publication
(10) Pub. No.: US 2001/0049606 A1
(43) Pub. Date: Dec. 6, 2001

(54) Online collectible authentication and ownership system

(76) Inventor: Bruno Lucarelli, Tinton falls, NJ (US)

Correspondence Address: BRUNO LULARELLI, 5 POLO CLUB DRIVE, TINTON FALLS, NJ, 67724, US

(21) Appl. No.: 09/865,768

(22) Filed: May 25, 2001

Related U.S. Application Data
(60) Provisional application No. 60/209,324, filed on Jun. 5, 2000.

(51) Int. Cl. G06F 17/60

(52) U.S. Cl. 705/1

(57) ABSTRACT

An Internet-based system for registering and assuring authentication of a unique, collectible item is provided which includes an individual web page hosted by an online company for that unique item, wherein the web page displays a digital image, written description and current owner of that unique item. The individual web page is assigned a unique URL address and password. This web page represents an electronic title of ownership viewable by any Internet connection worldwide in a format that excludes the owner's personal information. As the object is sold, traded or otherwise changes owners, this process is facilitated by the additional exchange of the Internet-based electronic title, as the current owner transfers the password to the new owner who subsequently changes the personal ownership information on the electronic title.

This application claims priority from U.S. Provisional Application Ser. No. 60/209,324, filed Jun. 5, 2000 by the same inventor entitled ONLINE COLLECTIBLE AUTHENTICATION AND OWNERSHIP SYSTEM the entire disclosure of which is hereby incorporated by reference.

### FIELD OF THE INVENTION

The present invention relates to the field of authentication and ownership of unique and collectible items.

### BACKGROUND OF THE INVENTION

Articles that exist or are created in a limited number are in many cases collected by individuals with an interest in the field that article is associated with, such as artwork, celebrity memorabilia or items with significant historical value. The value of these items is often directly related to the number of items that are known to exist at the time the article is appraised or otherwise valued. Recently, the Internet has become a convenient and popular method of selling, auctioning or exchanging of the aforementioned types of items among collectors and other aficionados. However, to the detriment of the public in general and collectors in particular, unscrupulous practitioners have taken advantage of the anonymous nature of the Internet to illegally produce, package and misrepresent many types of items as being of a limited nature. This wave of Internet inspired counterfeiting has called into question the origin of all items represented by sellers as limited or authentic.

U.S. Pat. No. 5,285,383 purports to disclose a system and method for carrying out transactions of goods using an electronic title. This system assigns a unique tracking number through a database that controls and tracks the flow of goods in the manufacturing and shipping processes, replacing the traditional paperwork typical to these processes. U.S. Pat. No. 5,521,815 purports to disclose a uniform system for verifying and tracking articles of value using a database operating in a “client-server” computer environment for use in creating a title history file and for assigning a coded title number and for storing relevant data on the item. These systems and methods and those like them rely on the integrity of a single database to protect all entries. All information is accessible through a single URL, subsequently gaining access through a database password or code. One breach of security can compromise the entire group of titles. In addition, one virus can wipe out an entire database, again compromising the integrity of the system for the majority of users.

Thus, it is an object of the present invention to provide a centralized uniform system for creating an up-to-date, globally accessible Uniform Resource Locators stipulating public rights of ownership of all registered objects of value throughout that object's life-cycle.

U.S. Pat. Nos. 5,267,756 and 5,380,047 purports to disclose an authentication system which features a tamper-proof hologram attached to the limited edition items, including a unique ID number. A database containing a record of each item and how it is incorporated into the system is kept by the organization that administers the registration process.

U.S. Pat. No. 5,971,435 purports to disclose a method and system for confirming the origin of an autographed item through access to a database that corroborates the signing of the item(s), lists all code numbers, and identifies the owner of the article as is verified by their system.

U.S. Pat. No. 5,306,049 purports to disclose an authentication kit specifically for autographed sports memorabilia which requires the professional athlete to place their thumbprint on both the autographed item and a separate certification card that includes information on the athlete and signing. This system is intrusive on the athlete and provides no way to verify the actual authenticity of the thumbprint itself, as the general public has no such access to a “thumbprint database” of athletes or celebrities.

### SUMMARY OF THE INVENTION

There is a need in the field of authentication systems for unique and collectible items that combines easy accessibility by the public with high security for the owner of the item. The prior art describes methods and systems that are intended to either authenticate or track unique items of value. One of the drawbacks in the prior art authentication systems and methods is that the do not provide an easily accessible and secure system to the general public that provides an easily verifiable, third party public record of ownership for an item.

Specifically, in the prior art there are “tamper resistant” holograms and fingerprints affixes to the collectible items for providing security with the information regarding the collectible item being stored in the title registration company's database. However, a member of the general public would not know that the unique item existed unless being informed by the party selling the item due tot he restrictive nature of that company's access to the critical information. The buying party would have to contact the authentication company by phone or mail to obtain the information stored with regard to the unique item. A potential customer using an Internet search engine would not be able to locate the relevant information on the item in question, as it is stored in a closed, proprietary database.

These and other objectives of the present invention are achieved by assigning a “one-of-a-kind,” unique Internet-based Uniform Resource Locator (or URL) to each object registered under this system. This URL would represent a universally accessible, “systems-independent,” Online Title of Ownership, alterable only by a party that possesses the password that is assigned specifically to that URL.

The unique URL can contain an existing manifestation of a company's idenfification system, such as a serial number. Otherwise, the Online Title of Ownership system will generate a random title number and incorporate these characters into the URL.

The unique password is assigned upon creation of the page and given to the manufacturer, owner or creator of the unique item(s). The password and URL assigned to that object are then passed on to the purchaser or new owner of the object, who are encouraged to log on and take public possession of their unique item.

The only areas of the Online Title of Ownership Web Page that are alterable are fields indicating owner's name and e-mail or other similar identifying information. The current owner of an object can choose to expose as little or as much of this information as they wish through initiating a privacy feature on the registration page.

There is also a voice-recognition software feature where a new owner can call a phone number, read each individual character into the system, enter the password either vocally or through a phone keypad and register without having online access.

If a current owner of a registered object wishes to sell or otherwise transfer the item to a new owner, they provide the new owner with the current password either before, during or after the transaction. The new owner can immediately change the password to ensure security.

### BRIEF DESCRIPTION OF THE DRAWINGS

FIG. 1 depicts a collectible, limited edition item that has been created by a manufacturer.

FIG. 2 depicts the manufacturer's assignment of that item's unique place in a limited edition series, represented here by a certificate created by the manufacturer.

FIG. 3. depicts the physical embodiment of a digital image and description of the item as provided by the manufacturer, represented here by a computer disk and/or e-mail.

FIG. 4, is a flow diagram which depicts the creation of the Online Title of Ownership through a software program.

FIG. 5. depicts a version of a finished Online Title of Ownership with a globally unique and accessible URL.

FIG. 6. depicts the title company's “change of ownership” form used by the registered item's owner to prove or transfer ownership.

FIG. 7. depicts how multiple users can access the company's website and that all Title information is stored on the Title Company's servers.

FIG. 8. is a flow chart illustrating the process of creating the Online Titles of Ownership.

### DETAILED DESCRIPTION OF THE PREFERRED EMBODIMENTS

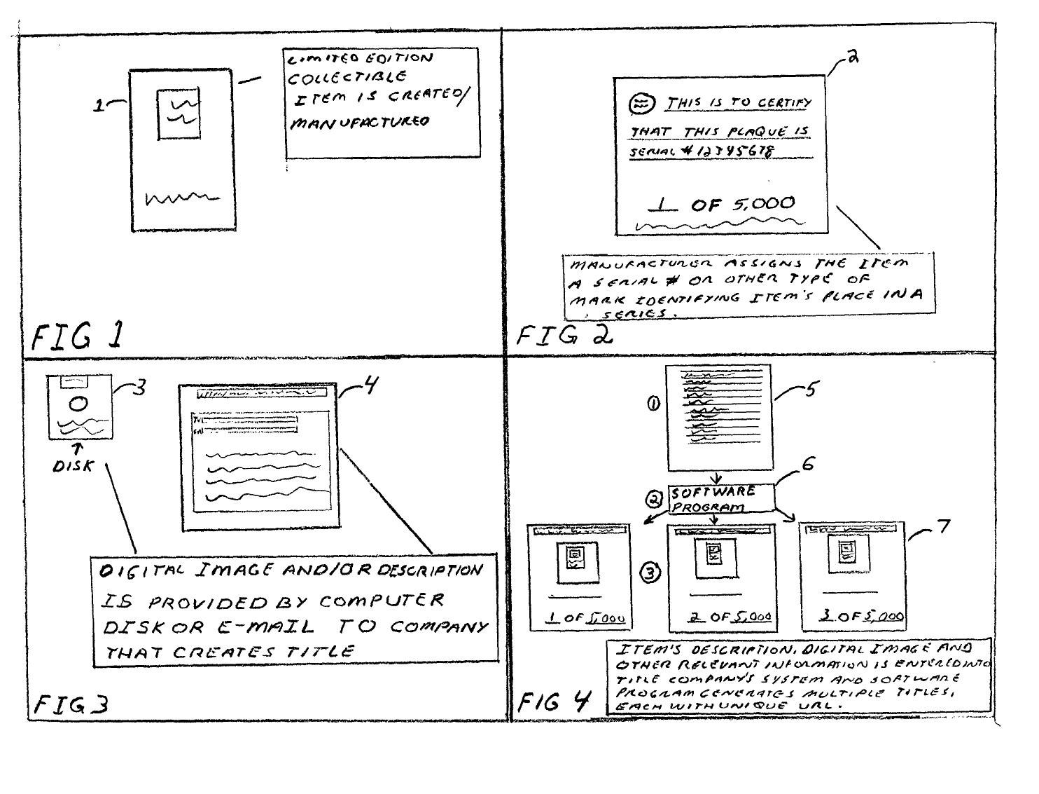

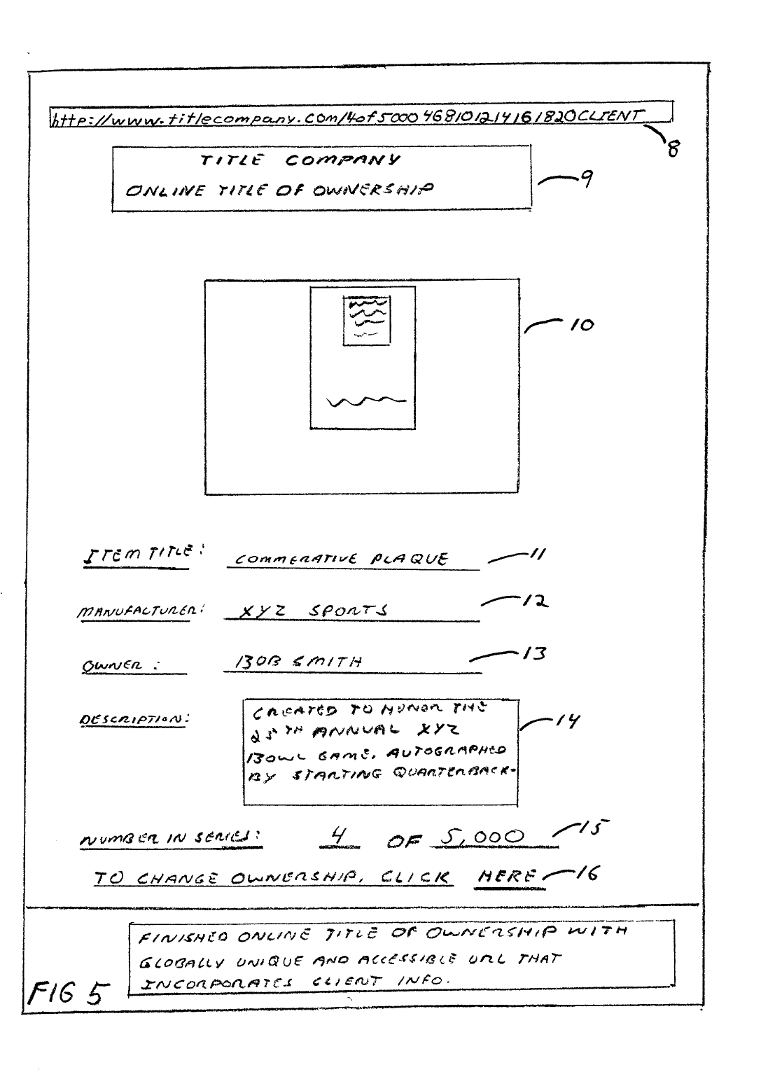

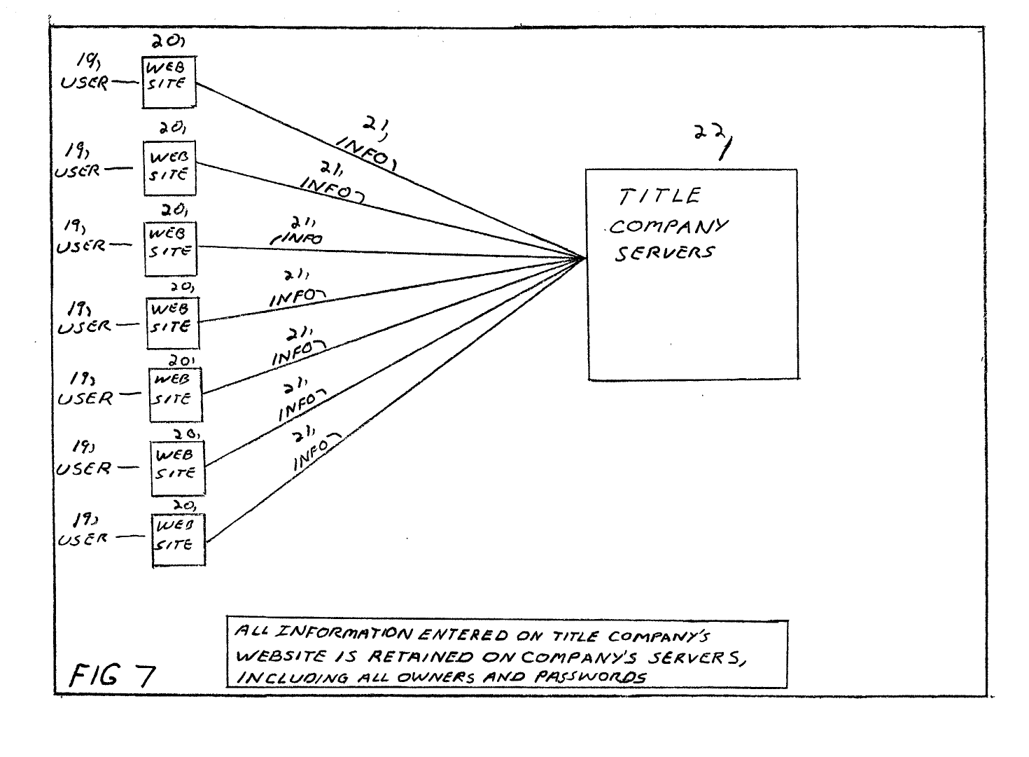

FIGS. 1-7 refer to an embodiment of the present invention for an on-line title registration system for a limited edition or otherwise unique item 1. The online title system includes a unique item 1, a written description of the item 4, a website 20 and webserver 22 hosting a unique URL 8, an online title 9, and allowing access only with a registered password 17.

Specifically, depicted in FIG. 1 is the unique item 1, in this instance a collectible plaque, created by a manufacturer to commemorate a sporting event and limited to a pre-set number of items in that series. An identifying serial number and certificate 2 is assigned to that plaque as an example of only one kind of identifying mark or manufacturer-assigned system that proves that item's place in the series. Further, the present invention is not limited to items related to sports but may be used to track the ownership of any type of collectible or unique item, including but not limited to artwork, vintage autos, celebrity autographed merchandise and memorabilia or any other item which, due to its unique nature, and/or limited availability, is considered valuable.

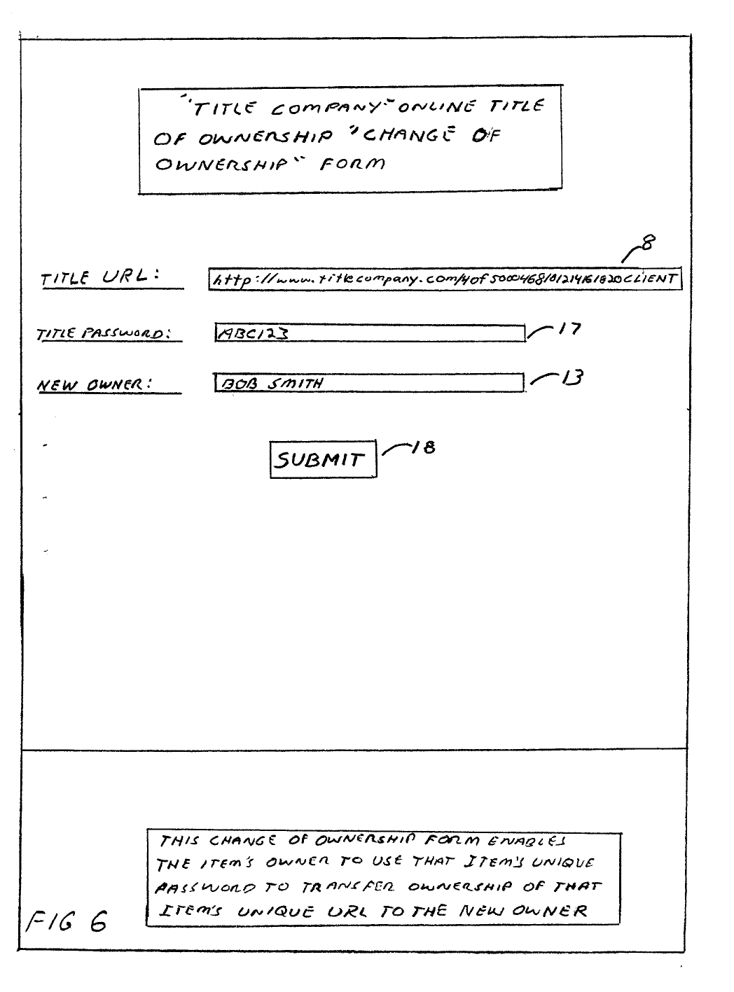

As depicted in FIG. 3, a written description 4 and digital image on disk 3 or e-mail 4 of the item may be provided the title company to create the unique URL 8 and online title 9. These may transmitted electronically or physically provided on computer disk 3. The average item description is 30 to 60 words in length.

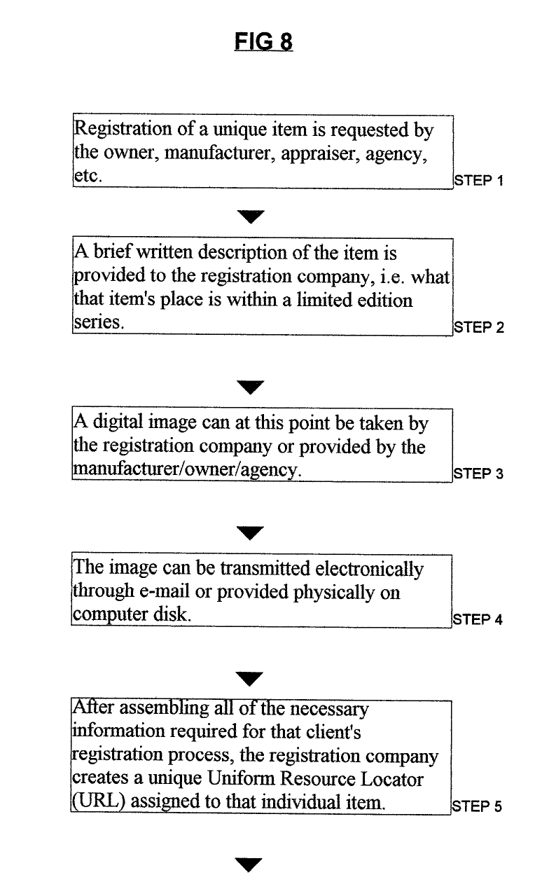

FIG. 5. depicts a finished online title 9. It includes a digital image 10, the title of the item 11, the manufacturer of the item 12, the registered owner of the item 13 (the owner can choose to reveal this but it will automatically default to a blank), the manufacturer's description of the item 14, the item's number in the limited series 15 (if necessary), and a field 16 to connect to the title change of ownership form.

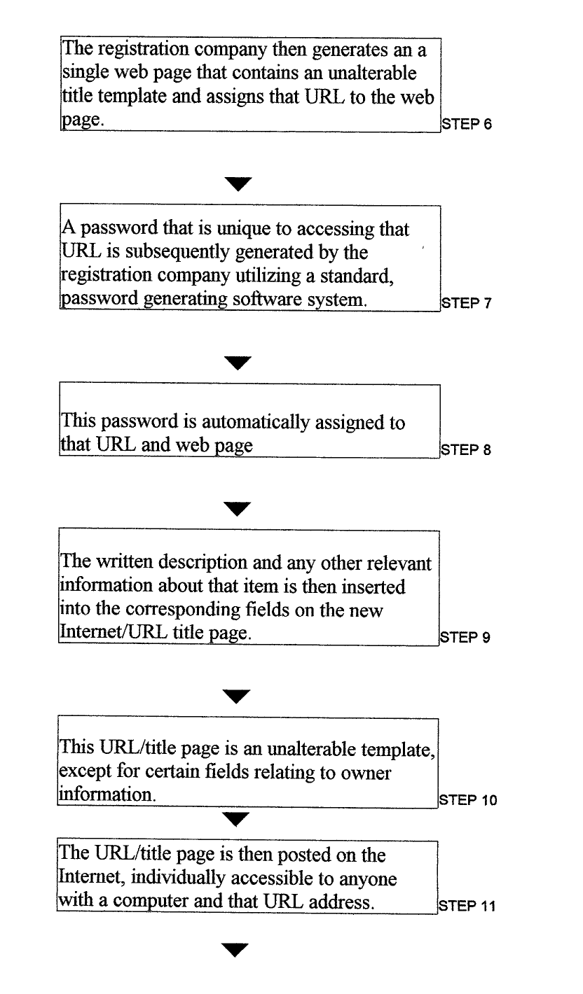

FIG. 6. depicts the online title's change of ownership form where a user would enter the title's unique URL 8, the title's password 17, enter the name of the new owner, and click on the submit button 18. The current owner receives an e-mail informing them that their title is in the process of changing hands.

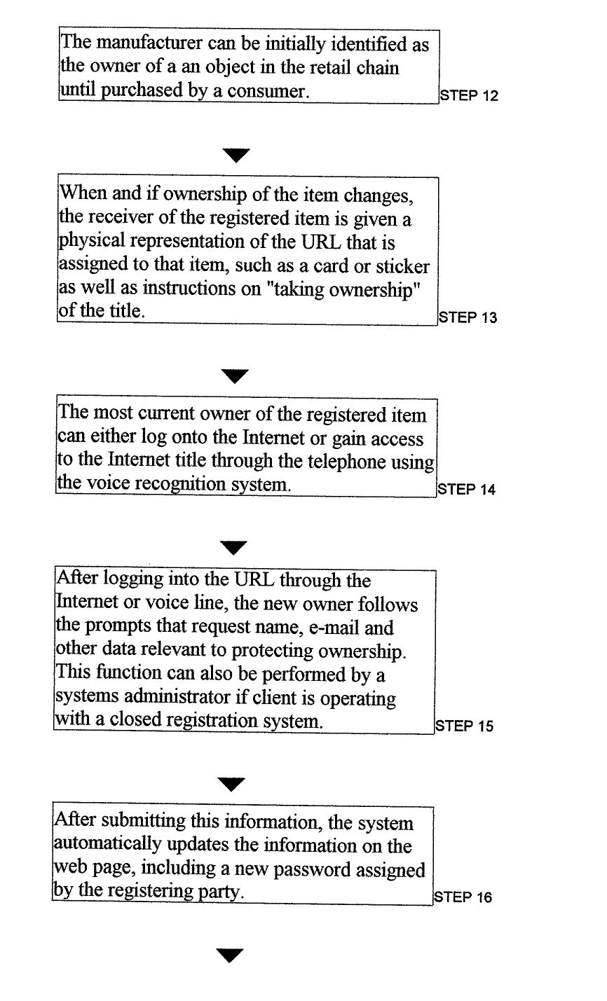

As shown in FIG. 7, multiple users 19 can access the title company's website 20 and all information 21 related to the online titles are stored in the company's servers, creating a centralized cache of information regarding current and past owners, passwords, and other relevant information important to insuring the integrity of the online title system.

In addition, in accordance with further aspects of the present invention, the online titles can be indexed by category and/or searched by a database search engine using any keywords. In other embodiments, a company that is licensing such a system may protect any or all of the title pages from view, restricting the general public from accessing their website. Further, in accordance with another aspect of the present invention, online title holders can automatically list their items for sale or auction through a system provided by the host site. However, the owner can always sell the item on their own as they own the online title outright for the time allotted in their user agreement.

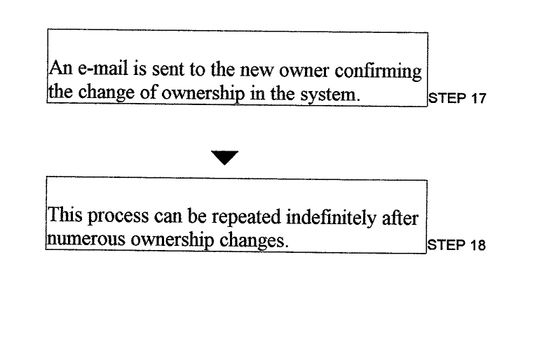

The steps to be followed in practicing the present system for authenticating unique and collectible items are set forth in the flow diagram of FIG. 8. In step 1, the unique item 1 is created or manufactured. A brief, written description of the item 5 is provided to the registration company, step 2. At this point, a digital image 4 of the item can be taken by or provided to the registration company, step 3, 4.

In step 5, upon receiving the all of the information necessary to distinguish the item 1 from any other piece, the registration company creates and assigns a unique URL 8 to that individual item. A single web page 9 is subsequently generated by the registration company that contains an unalterable title template and the unique URL 8 is permanently assigned to that individual template 9, step 6. A password 17 is generated for that template utilizing a standard, password generating software system, step 7, and assigned to that template, step 8.

The written description 5 and any other relevant information is subsequently is then inserted into the corresponding fields in the template 9, step 9. Step 10 declares the template 9 and URL 8 unalterable, except by a user that possesses the template's password. 17. Subsequent to the creation of the template 9, the title page is posted on the Internet, accessible to any computer with that address, step 11.

In order to ensure an orderly transition of ownership, the manufacturer is initially identified as the owner of any registered object until the object is purchased and registered by a customer, step 12. The latest owner of a registered object 1 is given some sort of physical representation of that objects unique URL 8 as to provide access to the online title of ownership 9, step 13. As described in step 14, the most current owner of a registered object 1 can either log onto the Internet or gain access to the template 9 through a standard voice recognition interface to assume electronic ownership of the item 1.,

After gaining access, the new owner follows either the written, online instructions or voice prompts, providing the information necessary to register the object in their name, step 15.

The updated information is assigned to the relevant URL 8 and template 9 in step 16.

In step 17, the registration company's automated software automatically sends an e-mail to the newest owner confirming the registered change of electronic ownership.

Finally, this process can be repeated indefinitely if the registered object 1 has numerous ownership changes, step 18.

The embodiments described above are not intended to be exclusive. There are other variations of the present invention that would be obvious to those skilled in the art, and are contemplated to be within the scope of the appended claims.

What is claimed is:

1. An Internet-based system for registering and tracking any unique or collectible item comprising:
a web service that contains an unalterable web page that represents an electronic title of ownership for the item
a unique URL address created for and assigned to that page.
a password based system that allow for change of ownership of other relevant information contained in the online, electronic title.

2. The Internet-based system of claim one, wherein a distinguishing feature of the unique item is noted.

3. The Internet-based system of claim 1, where a written description of the unique and collectible item is included in the individual electronic title.

4. The Internet-based system of claim 1, further comprising a digital image of the unique and collectible item is included in the individual electronic title.

5. The Internet-based system of claim 1, further comprising a document or other physical representation displaying the unique URL address and password of the electronic title of ownership

6. A publicly accessible, Internet-based title registration system for unique items consisting of:
a web service hosting the electronic titles of ownership
each page having a unique URL address assigned to the title it represents
each electronic title containing a written description of the unique, collectible item
each electronic title accessible only by the assigned password
each electronic title accessible to the general public in read only format, excluding the personal information related to the owner of that page

7. The Internet-based electronic title system of claim 6, where a written description and/or digital image is incorporated into the online title.

8. The Internet-based electronic title system of claim 6, further consisting of a physical representation containing the unique URL address of the electronic title of ownership as well as the title's password and instructions on transferring ownership either by online registration or voice-recognition through a telephone

9. The Internet-based system of claim 6, where the web service that hosts the individual, unique title of ownership can offer a separate auction area

10. An Internet-based method of registration for unique items comprising the steps of:
confirming the origin of the collectible item
creating an Internet-based template for a unique item
creating a unique URL address for assignment to a unique item
creating a password to restrict access to that web page and
assigning the unique password to each subsequent owner of the Internet-based title for the purpose of updating ownership information only
